(19) United States
(12) Patent Application Publication
(10) Pub. No.: US 2006/0149550 A1
(43) Pub. Date: Jul. 6, 2006

(54) Multimodal interaction

(76) Inventor: Henri Salminen, Ruutana (FI)

Correspondence Address: PERMAN & GREEN, 425 POST ROAD, FAIRFIELD, CT, 06824, US

(21) Appl. No.: 11/026,447

(22) Filed: Dec. 30, 2004

(51) Int. Cl. G10L 11/00

(52) U.S. Cl. 704/270.1

(57) ABSTRACT

In order to enable an application to be provided with multimodal inputs, a multimodal application interface (API), which contains at least one rule for providing multimodal interaction is provided.

### FIELD OF THE INVENTION

The present invention relates to multimodal interaction.

### BACKGROUND OF THE INVENTION

Output and input methods of user interfaces in applications, especially in browsing applications, are evolving from standalone input/output interaction methods to user interfaces allowing multiple modes of interaction, such as means for providing input using voice or a keyboard and output by viewing and listening. To enable this, mark-up languages are being developed. For the time being, solutions with different modalities being used to access a service at different time are known and multimodal service architectures with co-operating voice and graphical browsers are evolving.

Although multimodal browsing is evolving, utilizing multiple input modalities (channels) in software applications has not been brought into focus. Solutions developed for mark-up languages cannot be used with software applications as such, since a mark-up language is used for describing the structure of structured data, based on the use of specified tags, whereas a software application actually processes the data (which may be in a mark-up language), and therefore the requirements are different. In a software application capable of receiving inputs from two or more separate modalities, synchronization between different modalities is needed. For example, in order to perform one uniform controlling action of a software application, a user may have both to speak and point an item within a timeframe. Since the accuracy and lag between different modalities varies, timing might become crucial. This is a problem not faced at a mark-up language level with multimodal browsing since the internal implementation of a browser takes care of the timing, i.e. each browser interprets a multimodal input in its own way.

One solution is to implement multimodal interaction of a software application in a proprietary way. A problem with this solution is that every software application, which utilizes multimodal interaction, needs to be implemented with a separate logic for the multimodal interaction. For example, accuracy issues should be taken into account by confirmation dialogs. Thus, quite complex tasks are left to be solved by an application developer.

### BRIEF DESCRIPTION OF THE INVENTION

An object of the present invention is to provide a method and an apparatus for implementing the method so as to overcome the above problem. The object of the invention is achieved by a method, an electronic device, an application development system, a module and a computer program product that are characterized by what is stated in the independent claims. Preferred embodiments of the invention are disclosed in the dependent claims.

The invention is based on the idea of realizing the need for a mechanism supporting a multimodal input and the above problem and providing a high-level structure called a multimodal application programming interface (API) containing one or more rules for multimodal interaction, the rule or rules manipulating inputs according one or more rules. A rule may concern one modality or it may be a common rule concerning at least two different modalities.

An advantage of the above aspect of the invention is that it enables an application developer to design applications with multimodal control user interfaces in the same way as graphic user interfaces.

### BRIEF DESCRIPTION OF THE DRAWINGS

In the following, the invention will be described in greater detail by means of exemplary embodiments with reference to the accompanying drawings, in which

FIG. 1 illustrates an example of an application development system according to an exemplary embodiment of the invention;

FIG. 2 is a block diagram of a multimodal API according to an first exemplary embodiment of the invention;

FIGS. 3A and 3B show a pseudocode of a multimodal API according to the first exemplary embodiment of the invention;

FIG. 4 is a flow chart illustrating a simplified example of application creation with the multimodal API according to the first exemplary embodiment of the invention;

FIG. 5 shows a pseudocode indicating how the multimodal API of FIGS. 3A and 3B can be used;

FIGS. 6 and 7 are flow charts illustrating different implementations of the multimodal API;

FIG. 8 is a block diagram of a multimodal API according to a second exemplary embodiment of the invention;

FIG. 9 is a flow chart illustrating a simplified example of application creation with the multimodal API according to the second exemplary embodiment of the invention;

FIG. 10 shows a pseudocode indicating how the multimodal API according to the second exemplary embodiment of the invention can be used;

FIG. 11 is a flow chart illustrating use of the multimodal API according to the second exemplary embodiment of the invention;

FIG. 12 is a simplified block diagram of a module; and

FIG. 13 is a simplified block diagram of a device.

### DETAILED DESCRIPTION OF SOME EMBODIMENTS

The present invention is applicable to any application development system supporting multimodal controlling, and to any software application/module developed by such a system and to any apparatus/device utilizing multimodal controlling. Modality, as used herein, refers to an input or an output channel for controlling a device and/or a software application. Non-restricting examples of different channels include a conventional mouse, keyboard, stylus, speech recognition, gesture recognition and haptics recognition (haptics is interaction by touch), input from an in-car computer, distance meter, navigation system, cruise control, thermometer, hygrometer, rain detector, weighing appliance, timer, machine vision, etc.

In the following, the present invention will be described using, as an example of a system environment whereto the present invention may be applied, a system relying on a Java programming language environment without restricting the invention thereto; the invention is programming language independent.

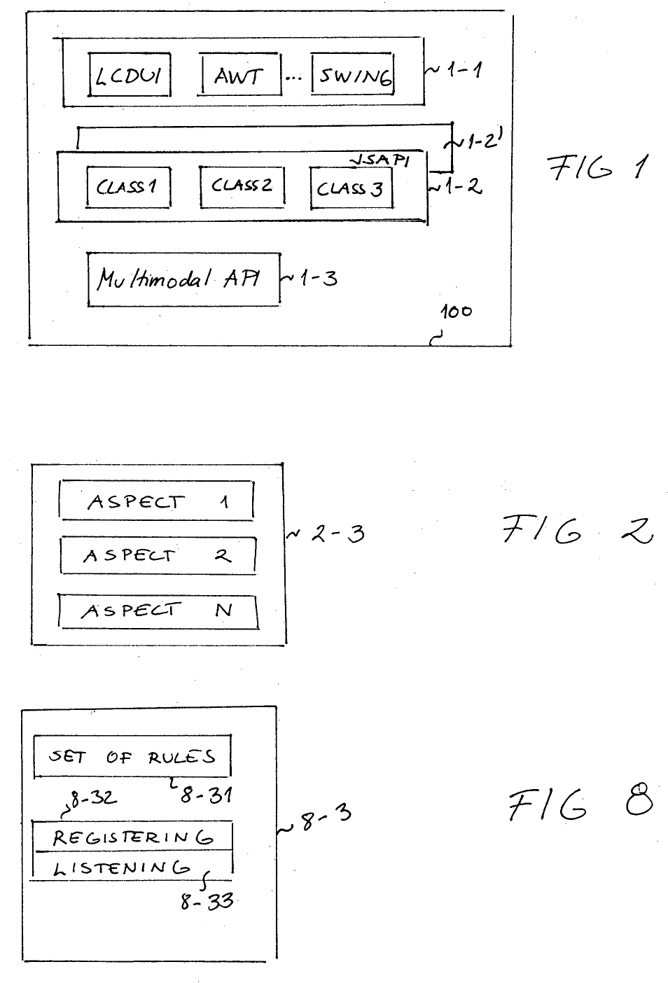

FIG. 1 illustrates architecture of an application development system 100 according to an embodiment of the invention. The exemplary application development system comprises graphic user interface (GUI) frameworks 1-1, different modality APIs 1-2, 1-2′ and a multimodal API 1-3. The existing GUI frameworks and future GUI frameworks may be utilized with the invention as they are (and will be), the invention does not require any changes to them, or set any requirements for them either. The same applies also to different modality APIs.

A number of GUI frameworks 1-1 exist for Java, such as those illustrated in FIG. 1, Swing, AWT (Abstract Window Toolkit) and LCDUI (liquid crystal display user interface for Java 2 Micro Edition (J2ME), i.e. for wireless Java applications), for example. Each GUI framework contains classes (not illustrated in FIG. 1). It should be noted, that the GUI frameworks here are just examples, any other frameworks may be used instead of or with a GUI framework.

In the example shown in FIG. 1, only one of the modality APIs is shown in detail, the modality API being Java Speech API JSAPI 1-2 containing different classes.

The multimodal API 1-3 provides an integration tool for different modalities according to the invention and different embodiments of the multimodal API 1-3 will be described in more detail below. The multimodal API 1-3 can be used in several applications in which multimodal inputs are possible, including but not limited to applications in mobile devices, vehicles, airplanes, home movie equipment, automotive appliances, domestic appliances, production control systems, quality control systems, etc.

A first exemplary embodiment of the invention utilizes aspect-oriented programming. Aspect-oriented programming merges two or more objects into formation of the same feature. Aspects are same kind of abstractions as classes in object-oriented programming, but aspects are intended for cross-object concerns. (A concern is a particular goal, concept or area of interest and a crosscutting concern tends to affect multiple implementation modules.) Thus, aspect-oriented programming is a way of modularizing crosscutting concerns much like object-oriented programming is a way of modularizing common concerns. A paradigm of aspect-oriented programming is described in U.S. Pat. No. 6,467,086, and examples of applications utilizing aspect oriented programming are described in U.S. Pat. No. 6,539,390 and US patent application 20030149959. The contents of said patents and patent application are incorporated herein by reference. Information on the aspect-oriented programming can also be found via the Internet pages http://www.javaworld.com/javaworld/jw-01-2002/jw-0118-aspect.html and http://eclipse.org/aspectj/, for example.

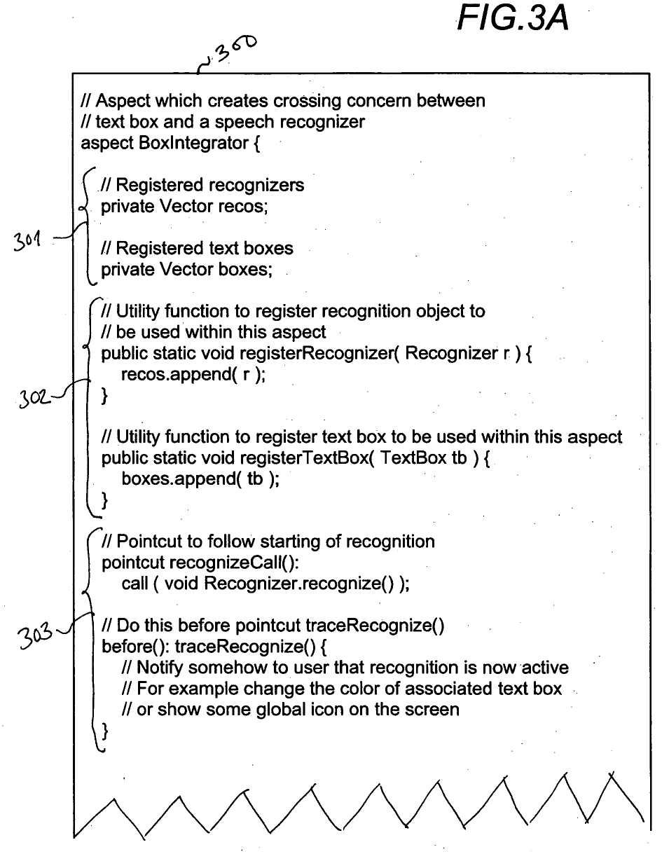

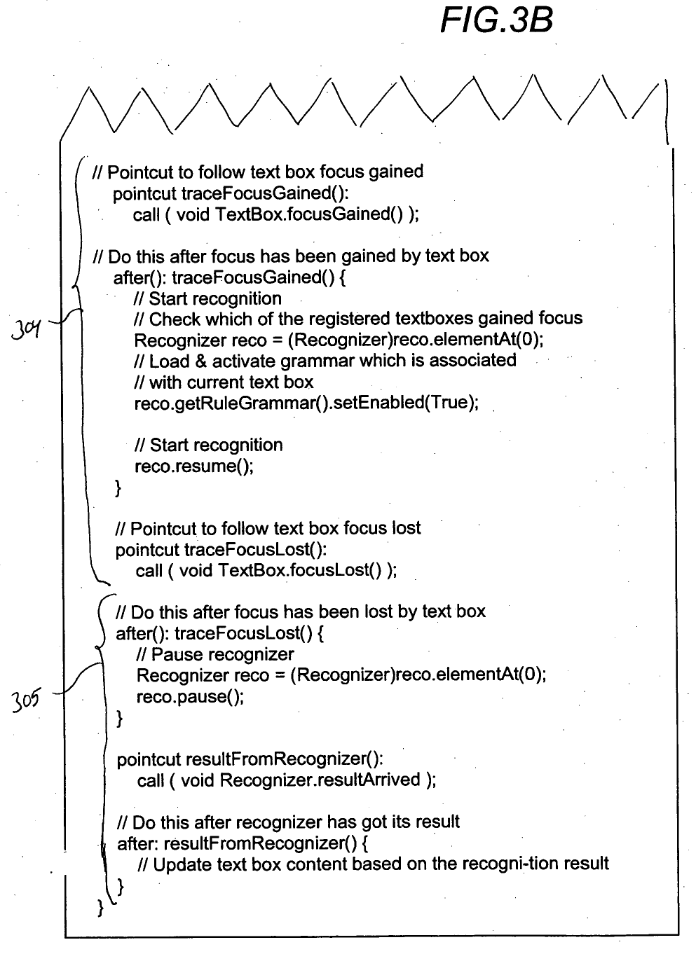

FIG. 2 illustrates the multimodal API according to the first exemplary embodiment of the invention in which the multimodal API is provided by one or more multimodal aspects, later called aspects. Depending on the implementation, the multimodal API comprises one or more aspects. An aspect represents integration of modalities into one interaction. Each aspect contains one or more rules to perform a multimodal interaction. For example, aspect 1 may be an aspect for integrating speech with gestures, aspect 2 may be an aspect for integrating speech with text given via a graphical user interface, and aspect N an aspect for integrating speech with gestures and with text. There may be an aspect integrating outputs of other aspects, i.e. aspects may be chained. Yet another possibility is that there is only one universal aspect integrating all possible multimodal inputs. Aspects may be implemented with a Java extension called AspectJ. An example of an aspect, a pseudocode for an aspect integrating speech and mouse input, i.e. two different ways to select an option from a text box, is shown in FIGS. 3A and 3B which form a single logical drawing. The pseudocode is loosely based on CLDC (Connected Limited Device Configuration) 1.0 and MIDP (Mobile Information Device Profile) 1.0, JSAPI 2.0 and AspectJ. A J2ME environment is formed by first creating a configuration containing basics, types, data structures, etc., and creating then, on the configuration, a profile containing higher-level features, such as LCDUI. As can be seen, an aspect 300 contains the actual integration and decides what is integrated and what is not, thus guaranteeing that the application program is controlled by synchronized and accurate modalities. By using this aspect, an application developer does not have to worry about these details any more. As can be seen in the example illustrated in FIG. 3, the aspect contains one or more rules 305 for different modalities. Different modalities to be integrated are defined in section 301, utility functions used with them are defined in 302, sections 303 and 304 define modality-specifically how recognition is performed.

FIG. 4 is a flow chart illustrating a simplified example of how an application developer can create an application utilizing the multimodal API according to the first exemplary embodiment. The application here is a multimodal user interface, such as a mobile information device applet (MIDlet). First, the application developer selects one or more suitable classes from a GUI framework (step 401), and one or more modalities APIs (step 402). The application developer then selects, in step 403, one or more suitable classes for each selected GUI framework and for each selected modality API. The application developer may have selected a text box implemented by LCDUI and a speech recognizer implemented by JSAPI. The application developer then selects, in step 404, a suitable aspect or suitable aspects for multimodal interaction and the application is ready. However, the application developer may configure the selected aspect(s) if needed. Thus, by selecting an aspect, a rule is selected but by configuring the aspect, the selected rule may be fine-tuned when necessary. In one embodiment of the invention, the rules of aspect may be dynamic, i.e. rules are modified according to input they receive. This input may comprise, but is not limited to, the input from the modality and/or other information, such as delay in speech recognition, reliability of speech recognition result, error messages inputted by the user or some other computer program module, or time interval of receiving input from two modalities, for example.

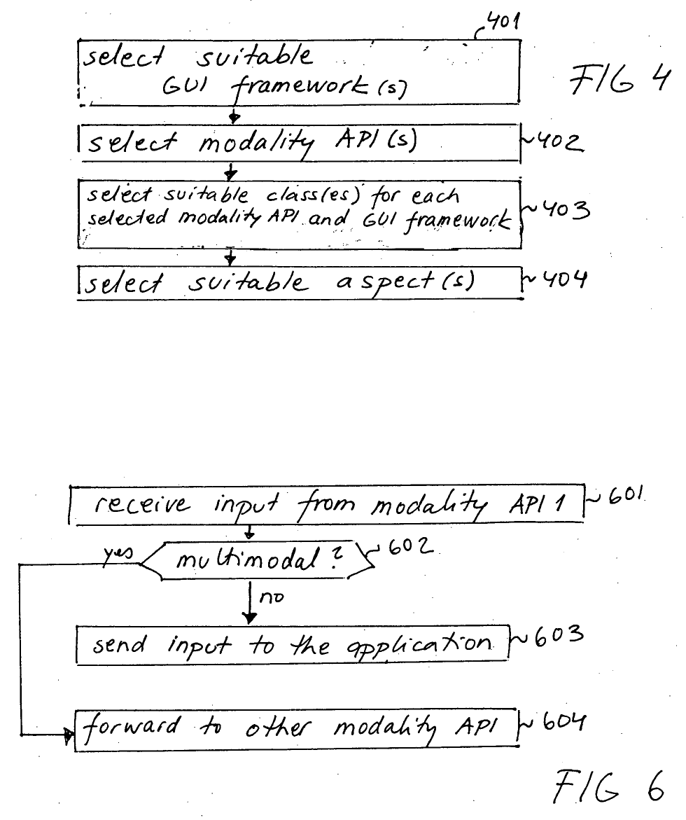

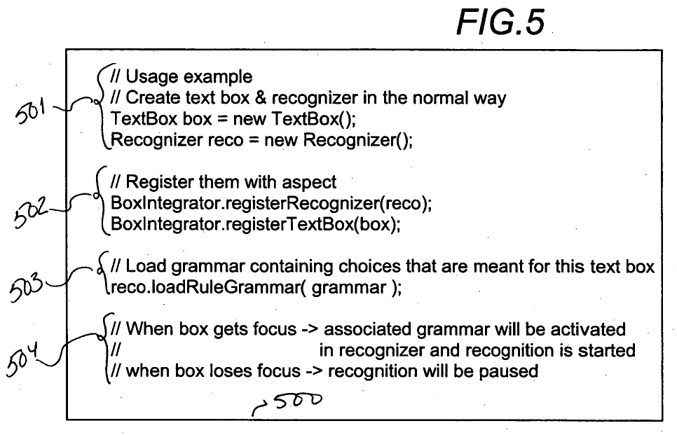

An example of how the application developer may use the aspect shown in FIGS. 3A and 3B is illustrated by the pseudocode in FIG. 5. Section 501 illustrates the outcome of the above-described steps 401 to 403, section 502 illustrates the outcome of the step 404 described above, and section 503 defines a tool to be used when the selections of different modalities (speech and text) will be mapped to each other. Section 504 gives some explanatory information commenting how the aspect functions, i.e. how the application receives interactions. The commented functionality is within the aspect. As can be seen, the aspect provides a guideline for multimodal interaction which can then be tuned by configuring the selected aspect.

FIG. 6 is an exemplary flow chart illustrating with a simplified example a first implementation of the multimodal API according to the first exemplary embodiment. For the sake of clarity, it is assumed that the application may receive inputs from two different modalities. This first implementation is referred as multimodal API utilizing aspect-oriented programming.

FIG. 6 starts when the multimodal API receives an input from a modality API 1 in step 601. In response to the received input, the multimodal API checks, in step 602, whether the input relates to multimodal interaction. If it does not relate to a multimodal event, the input is sent, in step 603, to the application. If the input relates to a multimodal event, the input is forwarded, in step 604, to another modality API according to associated rule in the modality API. The other modality API then recognizes that the input was received from the modality API and sends this received input as its own input to the application in request. In this exemplary embodiment, the multimodal API acts as an aspect, which handles the crosscutting concerns of different modalities. It provides a mechanism that only one input to a requesting application is obtained. The aspect handles and forwards the data it receives from the modalities according to rules.

FIG. 7 is a flow chart illustrating a second implementation of the multimodal API according to the first exemplary embodiment with a simplified example. Also here it is assumed, for the sake of clarity, that the application may receive inputs from two different modalities. This first implementation is referred as multimodal integrator.

FIG. 7 starts when the multimodal API receives an input from a modality API 1 in step 701. In response to the received input, the multimodal API checks, in step 702, whether the input relates to a multimodal event. If it relates to a multimodal event, the multimodal API waits, in step 703, a preset time for an input from the other modality API, modality API 2. The waiting time, i.e. a preset time limit, may be set when the multimodal API is being created. In another exemplary embodiment of the invention, the multimodal API may take account also other data it receives from modalities, lag in speech recognition, trustworthiness of speech recognition result, error messages received from the user or from other API's or computer program product, for example. The rules, which are used to integrate input from the modalities, may also be dynamic, i.e. the rules are modified according to information the multimodal API receives. If the other input is received (step 504) within the time limit, the multimodal API integrates, in step 705, the inputs together into one integrated input, and sends the input to the application in step 706. One example of integration is given: Let us assume that coffee is selected via a graphical user interface GUI, and after a few seconds, a selection “tea” is received via speech recognition. If the integration rule is that a GUI selection overrules other selections, the selection “coffee” is sent to the application. If the integration rule is that speech recognition overrules other selections or that the last selection overrules previous selections, the selection “tea” is sent to the application.

If no other input is received within the time limit (step 704), the multimodal API forwards, in step 706, the input received in step 701 to the application.

If the input does not relate to a multimodal event (step 702), the multimodal API forwards, in step 706, the input received in step 701 to the application.

The difference between these two implementations is described below with a simplified example. Let us assume that an application exists to which multimodal inputs may be given by choosing an alternative from a list shown on a graphical user interface, other inputs are single modality inputs requiring no integration. The alternative may be chosen by selecting it by a mouse click or by giving a spoken selection of a text box or by combining both ways. When a spoken input is received, the corresponding modality API forwards the input to the multimodal API. The multimodal API according to the first implementation described in FIG. 6 recognizes whether or not the spoken input is a selection of an alternative on the list and if the input is a selection, the input is forwarded to the “mouse click” modality, otherwise it is forwarded to the application. The multimodal API according to the second implementation described in FIG. 7 recognizes whether or not the spoken input is a selection of an alternative on the list and if it is a selection, the multimodal API waits for a predetermined time for an input from the “mouse click” modality, and if the other input is received, combines the inputs and sends one input to the application; otherwise the received spoken input is forwarded to the application.

In yet another embodiment of the invention, the integrator mechanism described in FIG. 7 may be implemented with aspect-oriented programming described in context of FIG. 6. This embodiment is referred as multimodal integrator with aspect-oriented programming. The multimodal API according to this embodiment acts as follows: When a spoken input is received, the corresponding modality API forwards the input to the multimodal API. The multimodal API according to the first implementation described in FIG. 6 recognizes whether or not the spoken input is a selection of an alternative on the list, and if the input is a selection, the input is forwarded to the “mouse click” modality; otherwise it is forwarded to the application. The multimodal API waits for “mouse click” modality to response to the input and after receiving response from the “mouse click” modality, the multimodal API forwards the result to the requesting application. It is to be understood, that multimodal API may also provide the requesting application with many other types of information.

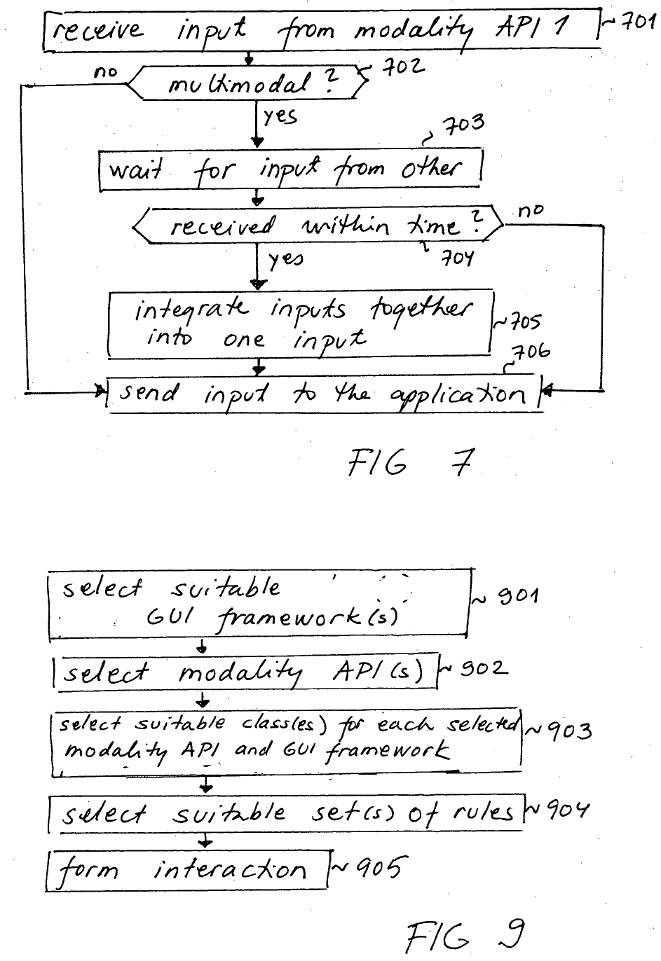

FIG. 8 illustrates the multimodal API according to a second exemplary embodiment of the invention in which the multimodal API is provided by one class or a package of classes. A multimodal API 8-3 according to the second exemplary embodiment comprises one or more sets of rules 8-31 (only one is illustrated in FIG. 8), registering means 8-32 and listening means 8-33.

The multimodal API 8-3 may contain a universal set of rules, or the set of rules may be application-specific or multimodal-specific, for example. However, a set of rules 8-31 contains one or more integration rules. A rule may be a predefined rule or a rule defined by an application developer during application designing, or an error-detecting rule defining itself on the basis of feedback received from the application when the application is used, for example. Furthermore, rules and sets of rules may be added whenever necessary. Thus, the invention does not limit the way in which a rule or a set of rules is created, defined or updated; neither does it limit the time at which a rule is defined. The set of rules here also covers implementations in which, instead of sets of rules, stand-alone rules are used.

The registering means 8-32 and the listening means 8-33 are means for detecting different inputs, and the detailed structure thereof is irrelevant to the present invention. They may be any prior art means or future means suitable for the purpose.

FIG. 9 is a flow chart illustrating a simplified example of how an application developer can create an application utilizing the multimodal API according to the second exemplary embodiment of the invention. The application here is, again, a multimodal user interface, such as a mobile information device applet (MIDlet). First, the application developer selects one or more suitable GUI frameworks (step 901) and one or more modality APIs (step 902). The application developer then selects, in step 903, one or more suitable classes for each selected GUI framework and for each selected modality API. The application developer may have selected a text box implemented by LCDUI and a speech recognizer implemented by JSAPI. The application developer then selects, in step 904, a suitable set(s) of rules or a suitable standalone rule(s) for multimodal interaction on the basis of the above selections. The application developer may also fine-tune the rules, if necessary. In another embodiment of the invention, the user may define rules, according to which the rules are dynamically modified during interaction. This embodiment may be utilized in a situation, in which the multimodal API deduces from the input that the user is relatively slow, for example. In such a situation, the multimodal API may lengthen the time it waits for input from a second modality. Finally, the application developer forms, in step 905, the required interaction on the basis of the above selections (steps 901-904), and the application is ready.

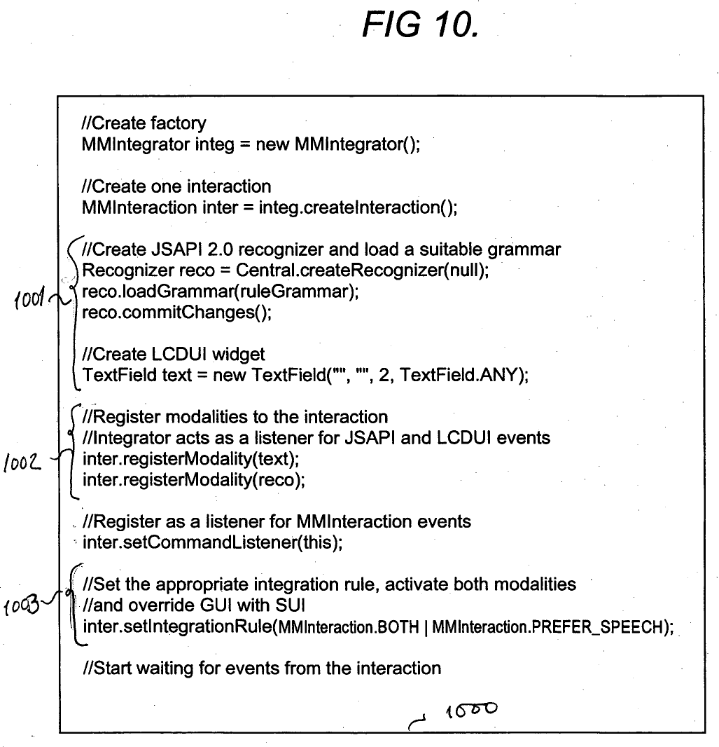

An example of how the application developer may create an application using the multimodal API according to the second exemplary embodiment of the invention is illustrated by the pseudocode in FIG. 10. The pseudocode is based on a J2ME/MIDP LCDUI graphical UI and a JSAPI 2.0 speech API. In the pseudocode of FIG. 10, the multimodal API, named an integrator, integrates a speech and a mouse input, i.e. two different ways to select an option from a text box. Section 1001 illustrates a selected modality API(s) and GUI framework(s), section 1002 selecting their classes, section 100 and section 1003 setting an integration rule.

Although above it has been stated that the application developer selects the set(s) of rules or stand-alone rule(s), the embodiment is not limited to such a solution. The set(s) of rules or stand-alone rule(s) or some of them may be selected by the application.

FIG. 11 is a flow chart illustrating with a simplified example a second implementation of the multimodal API according to the first exemplary embodiment. Also here it is assumed, for the sake of clarity, that the application may receive inputs from two different modalities.

FIG. 11 starts, when the multimodal API listens, in step 1101, events and results from the modalities. In other words, the multimodal API waits for inputs from modalities. An input from a modality API 1 is then received in step 1102. In response to the received input, the multimodal API checks, in step 1103, whether the input relates to a multimodal event. If it relates to a multimodal event, the multimodal API waits, in step 1104, for an input from the other modality API, modality API 2, and a time limit defined by the selected rule set. If the other input is received (step 1105) within the time limit, the multimodal API integrates, in step 1106, the inputs together into one input, and sends the input to the application in step 1107. The example of an integration rule disclosed above in FIG. 7 may also be applied here.

If no other input is received within the time limit (step 1105), the multimodal API forwards, in step 1107, the input received in step 1102 to the application.

If the input does not relate to a multimodal event (step 1103), the multimodal API forwards, in step 1107, the input received in step 1102 to the application.

The functionality of the second exemplary embodiment is illustrated with a simplified example in which multimodal inputs may be given by choosing an alternative from a list shown on a graphical user interface, other inputs are single modality inputs requiring no integration. The alternative may be chosen by selecting it by a mouse click or by giving a spoken selection of a text box or by combining both ways. When a spoken input is received, the corresponding modality API forwards the input to the multimodal API. The multimodal API according to the second exemplary embodiment recognizes whether or not the spoken input is a selection of an alternative on the list and if it is a selection, the multimodal API waits for a predetermined time for an input from the “mouse click” modality and if the other input is received, combines the inputs and sends one input to the application; otherwise the received spoken input is forwarded to the application.

Although the embodiments and implementations have been illustrated above with two different modalities, it is obvious for one skilled in the art how to implement the invention with three or more different modalities.

The steps shown in FIGS. 4, 6, 7, 9 and 11 are in no absolute chronological order, and some of the steps may be performed simultaneously or in an order differing from the given one. Other functions can also be executed between the steps or within the steps. Some of the steps or part of the steps can also be omitted. For example, if the modality APIs can themselves recognize whether or not an input relates to multimodal action and, on the basis of the recognition, send the input either directly to the application or to the multimodal API, steps 602, 702 and 1103 can be omitted. Another example relating to applications requiring multimodal inputs is that if no other input is received within the time limit, the multimodal API sends the application an input indicating that an insufficient input was received, instead of forwarding/sending the received input.

Below, a module and a device containing a multimodal API will be described in general. Detailed technical specifications for the structures described below, their implementation and functionality are irrelevant to the present invention and need not to be discussed in more detail here. It is apparent to a person skilled in the art that they may also comprise other functions and structures that need not be described in detail herein. Furthermore, it is apparent that they may comprise more than one multimodal API.

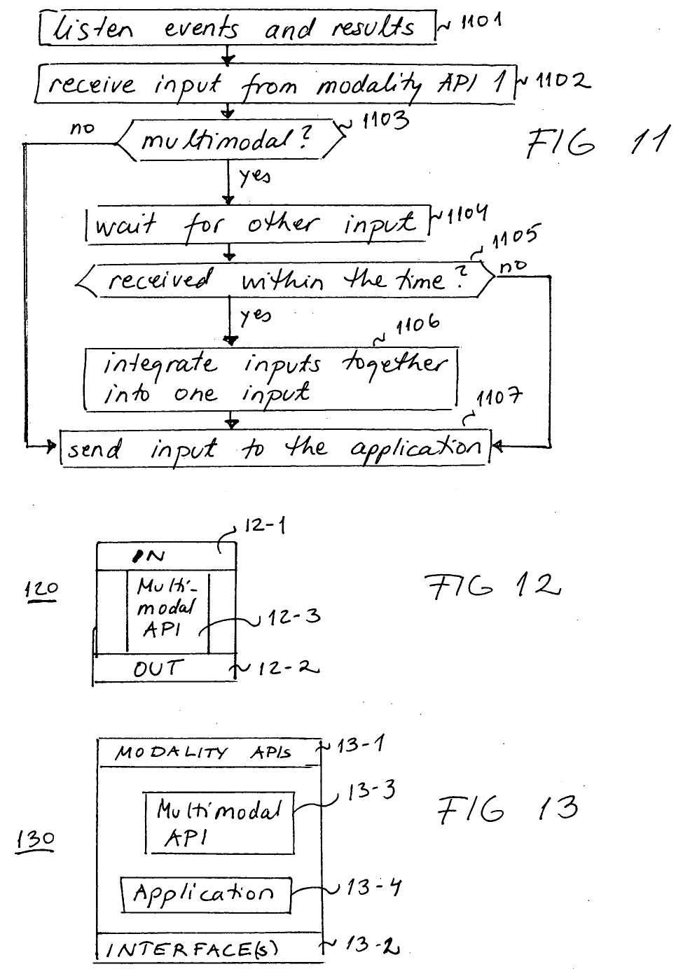

FIG. 12 is a block diagram illustrating a module 120 according to an embodiment of the invention, the module preferably being a software module. The module contains one or more interfaces for inputs 12-1, one or more interfaces for outputs 12-2 and a multimodal API 12-3 according to the invention, such as those described above, for example. The module may be an applet type of application downloadable to different devices over an air and/or via a fixed connection or a software application or a computer program product embodied in a computer readable medium. In other words, the software module may be described in the general context of computer-executable instructions, such as program modules.

FIG. 13 is a block diagram illustrating a device 130 according to an embodiment of the invention. The device contains two or more different modality APIs 13-1 for inputs and interfaces 13-2 for output(s). Furthermore, the device contains one or more applications 13-4 and one or more multimodal APIs 13-3, such as those described above, for example, the multimodal API integrating multimodal inputs for the application or applications. Alternatively, or in addition to, the device may comprise the above-described module. The implementation of the device may also vary according to the specific purpose to which the present invention is applied to and according to the embodiment used.

The system, modules, and devices implementing the functionality of the present invention comprise not only prior art means but also means for integrating inputs from two or more different modalities. All modifications and configurations required for implementing the invention may be performed as routines, which may be implemented as added or updated software routines, application circuits (ASIC) and/or programmable circuits, such as EPLD (Electrically Programmable Logic Device) and FPGA (Field Programmable Gate Array). Generally, program modules include routines, programs, objects, components, segments, schemas, data structures, etc. which perform particular tasks or implement particular abstract data types. Program(s)/software routine(s) can be stored in any computer-readable data storage medium.

It will be obvious to a person skilled in the art that as technology advances the inventive concept can be implemented in various ways. The invention and its embodiments are not limited to the examples described above but may vary within the scope of the claims.

1. A method for providing interaction between modalities, the method comprising at least:
receiving at least one input from at least one modality;
manipulating the at least one input according to at least one rule concerning at least one modality; and
sending the result of the manipulation to at least one of the group of other modality and an application.

2. The method of claim 1, in which the aspect-oriented programming is utilized in manipulating the at least one input.

3. The method of claim 1, in which a multimodal integrator is utilized in manipulating the at least one input.

4. The method of claim 1, in which multimodal integrator with aspect-oriented programming is utilized in manipulating the at least one input.

5. The method of claim 1, in which the at least one rule is manipulated according to input from the one least one modality.

6. A module for providing interaction between modalities, the module being capable of receiving inputs from at least two different modalities, the module comprising at least
means for manipulating at least one input received from at least one modality according to at least one rule concerning at least one modality; and
means for sending the result of in the manipulation to at least one of the group of other modality and an application.

7. The module as claimed in claim 6, wherein the module comprises at least one aspect performing said manipulation.

8. The module as claimed in claim 6, wherein the module comprises at least two aspects chained to perform said manipulation.

9. The module as claimed in claim 6, wherein the module comprises at least one rule defining how said manipulation is performed.

10. The module as claimed in claim 6, wherein the at least one rule is manipulated according to said input from the at least one modality.

11. A computer program product for providing interaction between modalities, said computer program product being embodied in a computer readable medium and comprising program instructions, wherein execution of said program instructions cause the computer to
obtain at least one input from at least one modality;
manipulate at least one input according to at least one rule concerning at least one modality; and
send the result of in the manipulation to at least one of the group of other modality and an application.

12. The computer program product as claimed in claim 11, in which the aspect-oriented programming is utilized in manipulating the at least one input.

13. The computer program product as claimed in claim 11, in which the at least one rule is manipulated according to input from the at least one modality.

14. An electronic device capable of providing interaction between modalities, the electronic device being configured at least to
receive at least one input from at least one modality;
manipulate the at least one input according to at least one rule concerning at least one modality; and
send the result of combining the at least one input into at least one of the group of other modality and an application.

15. The electronic device as claimed in claim 14, in which the aspect-oriented programming is utilized in manipulating the at least one input.

16. The electronic device as claimed in claim 14, wherein the electronic device comprises at least one aspect performing said manipulation.

17. The electronic device as claimed in claim 14, wherein the integrator is configured to recognize whether or not an input relates to a multimodal interaction, and in response to the input not relating to a multimodal interaction, to forward the input directly to the application.

18. The electronic device as claimed in claim 14, in which the at least one modality is selected from a group of a mouse, a keyboard, a stylus, speech recognition, gesture recognition, haptics recognition, input from an in-car computer, distance meter, navigation system, cruise control, thermometer, hygrometer, rain detector, weighing appliance, timer and machine vision.

19. An application development system comprising at least one framework, at least one modality application programming interface and at least one multimodal application programming interface, the system providing means for at least
receiving at least one input from at least one modality;
manipulating the at least one input according to at least one rule concerning at least one modality;
sending the result of in the manipulation to at least one of the group of other modality and an application.

20. The application development system as claimed in claim 19, wherein said multimodal application programming interface is provided by at least one aspect comprising at least one rule.

21. The application development system as claimed in claim 19, wherein said multimodal application programming interface is provided by a set of rules, the system further comprising selection means for selecting, for an application, at least one framework, at least one modality application programming interface and at least one rule from the set of rules.

22. The application development system as claimed in claim 19, in which the aspect-oriented programming is utilized in manipulating the at least one input.
